(19) United States
(12) Patent Application Publication
(10) Pub. No.: US 2005/0188361 A1
(43) Pub. Date: Aug. 25, 2005

(54) Browser-based web site generation system and method

(76) Inventors: Henry Cai, Laguna Hills, CA (US); Fan Luo, Anaheim, CA (US)

Correspondence Address: Wang, Hartmann & Gibbs, 1301 Dove Street, Suite 1050, Newport Beach, CA, 92660-2812, US

(21) Appl. No.: 10/791,351

(22) Filed: Mar. 1, 2004

Related U.S. Application Data
(60) Provisional application No. 60/547,251, filed on Feb. 23, 2004.

(51) Int. Cl. G06F 9/45; G06F 15/16; G06F 17/24

(52) U.S. Cl. 717/148; 717/115; 709/217; 715/513; 715/501.1

(57) ABSTRACT

A web site generation system includes a client virtual machine (VM), a server virtual machine (VM), and a storage virtual machine (VM). The client VM runs as a foreground process, interfaces with a user, and includes a web browser. The server VM runs as a background process, communicates remotely with the client VM in response to an action request from the web browser, and autonomously generates a web site upon a single web site build command from the user via the web browser. The storage virtual machine (VM) is operatively coupled between the client VM and the server VM and is used to store web site content files and web pages.

### CROSS REFERENCE TO RELATED APPLICATION

This application claims the benefit of U.S. Provisional Application Attorney Docket No. B002-8200 entitled “A Web-Based File Management and Presentation System” filed Feb. 23, 2004, by the same inventors, the disclosure of which is incorporated herein in its entirety by reference.

### FIELD OF THE INVENTION

The invention relates generally to computing systems, and more particularly to a browser-based web site generation system and method.

### BACKGROUND OF THE INVENTION

Computer users share data and media files via web sites, which consist of web pages that are linked together and written typically in Hypertext Markup Language (HTML). One problem with generating HTML web pages is the inherent cost in learning HTML as well as the time required to develop enough skills to be able to develop relatively error-free web pages. Traditional tools to author HTML web pages provide an integrated development environment, but a user who desires to share web site content must learn how to use a respective web site generation tool and must still program web pages one image and one hyperlink at a time.

Another problem is that it is not easy to retrieve web site content that has been organized using standard file systems. Typically, a complex hierarchical file structure must be navigated in order to access shared content that is organized in a conventional manner.

Some web site generation tools are known to use a web browser. However, such web site generation tools require the use of run-time engines on either the server or client side in order to build web sites dynamically upon a user request. Consequently, the generated web site may not be viewed without a run-time engine.

### SUMMARY OF THE INVENTION

In accordance with one aspect of the invention, a web site generation system is configured for collecting, organizing and viewing web site content information by way of a web browser. The web site generation system is adapted to autonomously generate a web site after the web site content information is collected and organized upon a single web site build command via the web browser.

In accordance with another aspect of the invention, a system for generating a web site comprises a client virtual machine (VM) adapted to run on at least one computing device as a foreground process and interface with a user. The client VM includes a web browser. The system also comprises a server virtual machine (VM) adapted to run on at least one computing device as a background process and communicate remotely with the client VM in response to an action request from the web browser. The server VM is adapted to autonomously generate a web site upon a single web site build command from the user by way of the web browser. The generated web site includes at least one content file and at least one web page. The system further comprises a storage virtual machine (VM) operatively coupled between the client VM and the server VM and being used to store the content files and web pages.

In accordance with yet another aspect of the invention, a method for generating a web site comprises the steps of:
(a) presenting an initiator web site using a web browser;
(b) using the initiator web site to collect and organize web site content information;
(c) clicking once on the initiator web site to build a final web site; and
(d) autonomously building the final web site.

In accordance with still another aspect of the invention, a web site content collection and organization method comprises the steps of:
(a) viewing an initiator web site using a web browser;
(b) clicking on a content hyperlink on the initiator web site to open a target folder;
(c) locating a source folder using the functionality of the initiator web site; and
(d) copying and pasting web site content files from the source folder to the target folder.

In accordance with an alternative aspect of the invention, a web site content collection and organization method comprises the steps of:
(a) viewing an initiator web site using a web browser;
(b) clicking on the initiator web site to open a dialog box;
(c) navigating the dialog box to select at least one web site content folder;
(d) navigating the dialog box to select at least one web site content category; and
(e) associating the selected web site content category with the selected web site content folder.

In accordance with another alternative aspect of the invention, a web site content collection and organization method comprises the steps of:
(a) viewing an initiator web site using a web browser, the initiator web site having at least one “Shared Favorites” folder;
(b) using the web browser to open at least one web page that is to be added to the initiator web site; and
(c) adding the opened web page to the “Shared Favorites” folder.

These and other aspects of the invention will become apparent from a review of the accompanying drawings and the following detailed description of the invention.

### BRIEF DESCRIPTION OF THE DRAWINGS

The invention is generally shown by way of reference to the accompanying drawings in which:

FIG. 1 schematically illustrates a browser-based web site generation system in accordance with the invention;

FIG. 2 is a flow chart of a browser-based web site generation method in accordance with the invention;

FIG. 3 is a flow chart of a web site content collection and organization method in accordance with one embodiment of the invention;

FIG. 4 is a flow chart of a web site content collection and organization method in accordance with another embodiment of the invention; and

FIG. 5 is a flow chart of a web site content collection and organization method in accordance with yet another embodiment of the invention.

### DETAILED DESCRIPTION OF THE INVENTION

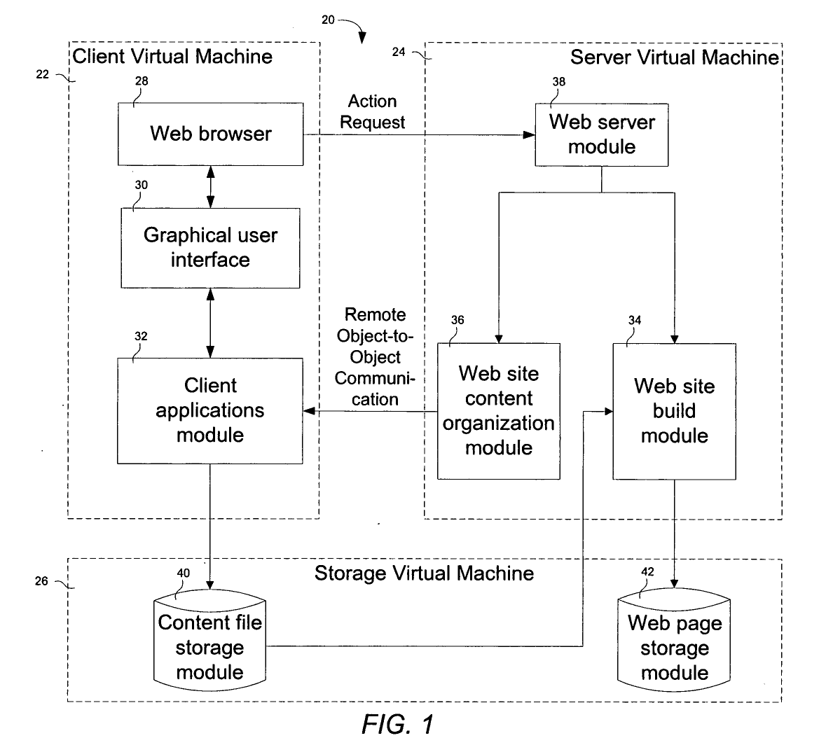

Some embodiments of the invention will be described in detail with reference to the related drawings of FIGS. 1-5. Additional embodiments, features and/or advantages of the invention will become apparent from the ensuing description or may be learned by practicing the invention.

In the figures, the drawings are not to scale with like numerals referring to like features throughout both the drawings and the description.

The following description is not to be taken in a limiting sense, but is made merely for the purpose of describing the general principles of the invention.

FIG. 1 schematically illustrates a browser-based web site generation system 20 including a client virtual machine 22, a server virtual machine 24, and a storage virtual machine 26, in accordance with the general principles of the invention. A virtual machine (VM) in general is an operating environment adapted to behave as a separate computing system. For example, Java™ applets and servlets are adapted to run in a Java™ virtual machine (VM) that insulates the applets and servlets from the underlying operating system.

The term “web site” generally refers to a series of web pages available on the World Wide Web (WWW). The WWW is a system of Internet servers adapted to support specially formatted documents. The documents are formatted in HTML which supports hyperlinks to other documents, as well as graphics, audio, and video files. HTML defines the structure and layout of a web document by way of tags and attributes. A user may navigate from one web document to another simply by clicking on hot spots which may appear in the shape of buttons, links or the like. Clicking may be generally defined as tapping on a computer mouse button, pressing it down and releasing it for the purpose of selecting an object displayed on a computer screen. The user moves the mouse pointer to the object's position on the screen and clicks an appropriate mouse button to select the object. Not all Internet servers are part of the WWW.

A number of software applications called web browsers have been developed for accessing the WWW such as, for example, Mozilla®, Netscape® Navigator™, Microsoft® Internet Explorer®, and the like. A web browser is a software application used to locate and display web pages. A web page is a document on the WWW. Every web page is identified by a unique URL (Uniform Resource Locator). Each web site has a home page, which serves as an index or table of contents to other documents stored at the web site. The home page is typically the first document users view upon entering the web site. The web site may contain additional documents and files. A web site may be owned and/or managed by an individual, company, government, organization or the like.

In accordance with one embodiment of the invention, client VM 22 is adapted to run as a foreground process, while server VM 24 is adapted to run as a background process. A foreground process can accept input from a keyboard, mouse, or other user input device. A background process may not accept interactive input from a user, but may access data stored on a disk and other system resources. For example, some word processing programs are designed to print files in the background, enabling the user to continue editing document(s) while files are being printed. A number of communications and anti-virus scan programs are also designed to run in the background. Background processes generally have lower priority than foreground processes so as not to interfere with interactive applications running in the foreground.

Client VM 22 includes a web browser 28, a client applications module (CAM) 32 and a graphical user interface (GUI) 30 operatively coupled between web browser 28 and CAM 32, as generally depicted in FIG. 1. The user interacts with web browser 28 via GUI 30. CAM 32 interacts with web browser 28 via GUI 30. CAM 32 may be implemented in a variety of ways. One implementation of CAM 32, for example, may include the functionality of Microsoft® Windows™ Explorer®. Other implementations of CAM 32 are possible, provided there is no departure from the intended purpose of the invention.

Server VM 24 includes a web server module (WSM) 38, a web site content organization module (WSCOM) 36, and a web site build module (WSBM) 34, as generally illustrated in FIG. 1. WSM 38 is programmed to serve the files that form web pages to users via GUI 30. WSM 38 also handles security characteristics and the loading and running of server-side programs, such as WSCOM 36 and WSBM 34. For example, WSM 38 may be implemented as an Apache™ server, a Microsoft® IIS™ (Internet Information Server), or the like. WSM 38 invokes the functionality of WSCOM 36 or WSBM 34 depending on the type of action request received from web browser 28, as schematically depicted in FIG. 1. An action request may be, for example, a Hypertext Transfer Protocol (HTTP) message. HTTP is the underlying protocol used by the WWW. HTTP defines how messages are formatted and transmitted, and what actions web servers and browsers should take in response to various commands. For example, when a user enters a URL in a designated field in web browser 28, a corresponding HTTP command is transmitted to WSM 38, which directs WSM 38 to fetch and transmit a respective web page.

In accordance with another embodiment of the invention, WSCOM 36 is adapted to communicate remotely with CAM 32 of client VM 22, on appropriate command from WSM 38, by means of a remote object-to-object communication set of protocols which may be implemented, for example, as RMI (Remote Method Invocation), CORBA (Common Object Request Broker Architecture), COM (Component Object Model), DCOM (Distributed Component Object Model) and the like. Other implementations may be utilized, provided such other implementations do not deviate from the spirit and scope of the invention.

RMI is a set of protocols, which was developed by Sun's Java Soft™ division to allow Java™ objects to communicate remotely with other Java™ objects. CORBA enables software objects to communicate with one another regardless of the programming language the objects were written in or the type of OS the objects are running on. CORBA was developed by an industry consortium known as the Object Management Group (OMG). Generally, an object is a self-contained software entity that consists of both data and procedures to manipulate the data. COM objects are unique discrete components, which expose interfaces that allow applications, and other components to access their features. DCOM allows COM objects to communicate across network boundaries.

WSCOM 36 is programmed to identify and organize media and data files that are to be shared in a browser-based web site generated in accordance with the general principles of the invention. WSCOM 36 interacts with CAM 32 using, for example, RMI to identify information that can be made available for viewing on the newly generated web site. The files identified by WSCOM 36 become the content files that would be available from the web site. The content files are organized into groups with the web site providing access to the grouped files via GUI 30 in the forms of hyperlinks, buttons or the like.

For example, in response to a user clicking on a “MUSIC” hyperlink provided on GUI 30, web browser 28 sends a corresponding action request to WSM 38, which, in turn, invokes WSCOM 36 to instruct remotely CAM 32 to run an appropriate client application, such as Windows™ Explorer®, to allow the user to view a respective folder containing music files via GUI 30. Specifically, a Windows™ Explorer® window appears on GUI 30 depicting the contents of a folder named E:\MYWEBSITE\MUSIC. The user would then run Windows™ Explorer® again to view a second folder named C:\MY_DOCUMENTS\MY_MUSIC, click down with the left mouse button on the icon for a file in this folder named FLUTE3.MP3, drag the icon over the E:\MYWEBSITE\MUSIC folder and release the mouse button so as to copy or move the FLUTE3.MP3 file into the E:\MYWEBSITE\MUSIC file folder. A person skilled in the art would recognize that the user may initiate such information requests by clicking on a hyperlink with the mouse, by tabbing to a hyperlink and then hitting the ENTER key, by autonomous processes, or by any other appropriate method supported by web browser 28.

CAM 32 is programmed to interact with the user through GUI 30 in response to remote requests from WSCOM 36 of server VM 24. Specifically, CAM 32 is designed to allow processes that run in the background to take advantage of resources that are only available in the foreground. Both WSCOM 36 and CAM 32 are high level applications which may be written in programming languages such as Java™, C, C++, and the like. These processes may have separate and distinct memory address spaces, and may even run on separate computers. In such a case, some type of remote procedure invocation or remote object access would be required.

Storage VM 26 is used for storing and retrieving data. Specifically, storage VM 26 includes a content file storage module (CFSM) 40 and a web page storage module (WPSM) 42, as generally shown in FIG. 1. CFSM 40 is operatively coupled between CAM 32 of client VM 22 and WSBM 34 of server VM 24, in accordance with the general principles of the invention. CAM 32 is adapted to store content files that may be used for web site building in CFSM 40, as schematically shown in FIG. 1. WPSM 42 is adapted to store web pages generated by WSBM 34. CFSM 40 and WPSM 42 may be implemented using internal disk drives, portable disk drives, Universal Serial Bus (USB) hard drives, or other mass-storage devices which are controlled by file system utilities or other processes for storing and retrieving digital information.

In accordance with yet another embodiment of the invention, WSBM 34 is adapted to autonomously retrieve information about the content files stored in CFSM 40 to build the HTML files that are needed to generate a new web site. These HTML files are stored in WPSM 42, as schematically shown in FIG. 1. Specifically, WSBM 34 is programmed to iterate through each of the content files stored in CFSM 40 and build web pages with hyperlinks for presenting these files via GUI 30 to the user. WSBM 34 inputs information about the data stored in CFSM 40 and outputs text files that are stored as web page files in WPSM 42. These web page files may be HTML files, XML (Extensible Markup Language) files, JavaScript™ files, or other document format files or scripts. For each group in which content files are organized by WSCOM 36, at least one index is created that provides hyperlinks to present these files to the user. For example, if music files are stored in a Music group, at least one portion of a web page will be generated by WSBM 34 providing hyperlinks for the music files in that group. This index may be an individual web page for music that includes hyperlinks to the music content files, or may be a portion of a larger web page that includes hyperlinks to the music content files along with other hyperlinks or information, or may include hyperlinks to additional web pages that allow the user to play the music content files.

For example, CFSM 40 may contain a folder E:\MYWEBSITE\MUSIC that includes “The Magic Flute” by Mozart stored in file FLUTE.MP3, and “Moonlight Sonata” by Beethoven in MOON.MP3. WSBM 34 would analyze these files to determine the titles and authors, and build a corresponding web page for music that may include the following HTML code:

<html><body><h1>Music</h1>
<table border=1><tr><td>File</td><td>Title</td><td>Author</td></tr>
<tr><td><a
href=“/E/MYWEBSITE/MUSIC/FLUTE.MP3”>FLUTE.MP3</a></td>

<td>The Magic Flute</td><td>Mozart</td></tr>

<tr><td><a
href=“/E/MYWEBSITE/MUSIC/MOON.MP3”>MOON.MP3</a></td>

<td>Moonlight Sonata</td><td>Beethoven</td></tr>

</table></body></html>

This HTML code, when presented in web browser 28, would display a table with the title “Music” and hyperlinks to content files FLUTE.MP3 and MOON.MP3.

In addition to iterating through each of the content files to build hyperlinks, WSBM 34 is also adapted to use setup information specified by the user. For example, the user may specify color preferences, fonts, languages, or skins to affect the overall look of the newly generated web site. These and other similar options are used by WSBM 34 to generate the web site.

After all content has been collected and organized, the user clicks once via GUI 30 on a previously created “One Click Update” button in web browser 28, to generate the new web site. An HTTP interaction between web browser 28 and WSM 38 follows:

Client VM Action Request:
GET http://www.myserver.com/servlet/UpdateWeb HTTP/1.0

Server VM Response:
HTTP/1.0 200 OK
Date: Mon, 12 Jan. 2004 20:18:59 GMT
Server: Apache/1.0.0
Content-type: text/html
Content-length: 1579
Last-modified: Mon, 12 Jan. 2004 17:16:32 GMT
<html><body> . . . (HTML document follows)
In addition to providing a response, WSM 38 invokes a servlet “UpdateWeb” to autonomously perform the tasks, which constitute WSBM 34.

Storage VM 26, client VM 22 and server VM 24 may be implemented to run on two, three or more computers, or may run on the same computer. In one embodiment of the invention, all three virtual machines are processes adapted to run on a single PC (Personal Computer). A process, in general, is an organized list of instructions that, when executed, causes the computer to behave in a predetermined manner. The PC may be adapted to run an OS, such as Windows™, Linux™, Mac OS™, UNIX™, OS/2™, FreeBSD™ or the like, to manage the processes.

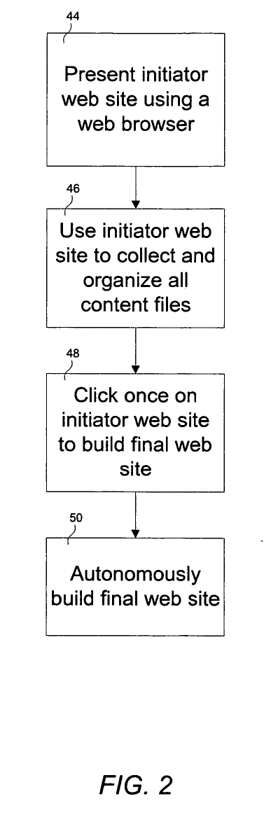

As generally illustrated in FIG. 2, browser-based web site generation system 20 may be implemented using the following functional steps:
(1) The user is presented with a pre-configured initiator web site using web browser 28, step 44. In one embodiment of the invention, the initiator web site is programmed to automatically assign a URL to the user once installed on the user's computer. The user may subsequently provide the URL to other users who desire to access the web site.
(2) The user utilizes the initiator web site to collect and organize all content files which are to be added to the initiator web site by invoking the functionality of web browser 28, WSM 38, WSCOM 36, CAM 32, CFSM 40, and GUI 30, as generally described hereinabove, step 46.
(3) Having collected and organized all content files, the user clicks once on a “One Click Update” button provided on the initiator web site to build the final web site which invokes the functionality of web browser 28, WSM 38, WSBM 34, CFSM 40, and WPSM 42, as generally described hereinabove, step 48. No further interaction is required by the user to build the final web site.
(4) WSBM 34 autonomously builds the final website by generating the requisite web pages and storing all generated web pages for the final web site in WPSM 42, as generally illustrated in FIG. 1, step 50. The stored web pages may be viewed or published for viewing by users, provided with the URL created in reference to step 44, in a variety of ways, as generally described hereinbelow.
Other ways of implementing browser-based web site generation system 20 may be utilized, provided such other implementations reside within the intended scope of the invention.

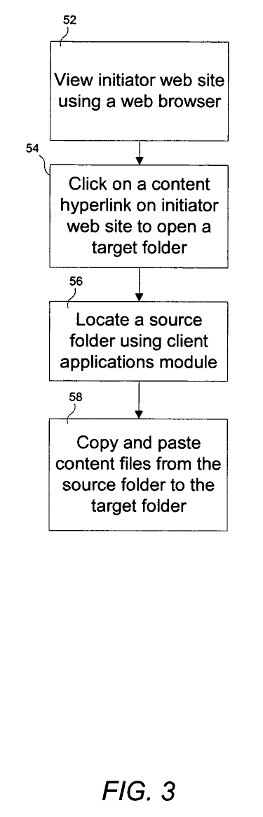

As generally depicted in FIG. 3, the collection and organization of web site content, before building the final web site of FIG. 2, may be implemented using the following functional steps:
(1) The user views a pre-configured initiator web site using web browser 28, step 52.
(2) The user clicks on a pre-defined content hyperlink on the initiator web site to open a corresponding target folder, step 54. The target folder may reside on the user's hard drive or on any other suitable type of computer storage media that is readily accessible from the user's computer.
(3) The user locates a respective source folder by invoking the functionality of web browser 28, GUI 30, CAM 32, and CFSM 40, as generally described hereinabove, step 56. The source folder may reside on the user's hard drive or on any other suitable type of computer storage media that is readily accessible from the user's computer.
(4) The user copies and pastes web site content files from the source folder to the target folder, step 58. The pasted web site content files are subsequently used by WSBM 34 to autonomously build the final web site.
The above steps may be repeated until all web site content has been collected and organized.

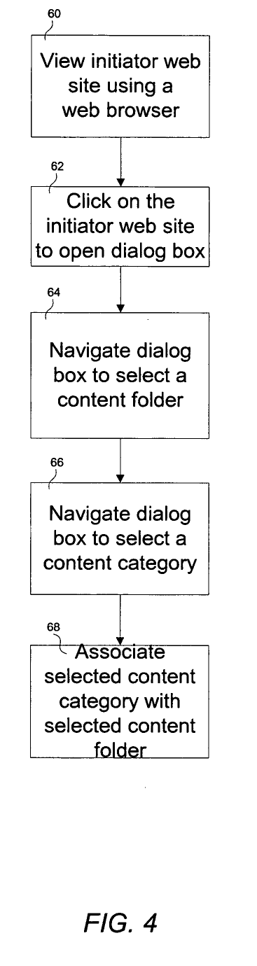

As generally depicted in FIG. 4, the collection and organization of web site content, before building the final web site of FIG. 2, may be implemented using the following alternative functional steps:
(1) The user views a pre-configured initiator web site using web browser 28, step 60.
(2) The user clicks on a pre-defined spot on the initiator web site to open a corresponding dialog box which invokes the functionality of web browser 28, GUI 30, CAM 32, and CFSM 40, as generally described hereinabove, step 62.
(3) The user navigates the dialog box to select a content folder, step 64. The selected folder contains a certain type of content files, such as, for example, picture files. The content folders may reside on the user's hard drive or on any other suitable type of computer storage media that is readily accessible from the user's computer.
(4) The user navigates the dialog box to select a content category, step 66. The selected category may be, for example, a picture category.
(5) The user associates the selected content category with the selected content folder by clicking on the dialog box “OPEN” button, step 68. The dialog box contains conventionally pre-defined “OPEN” and “CANCEL” buttons. The associated content folder is subsequently used by WSBM 34 to autonomously build the final web site.
The above steps may be repeated until all web site content has been collected and organized.

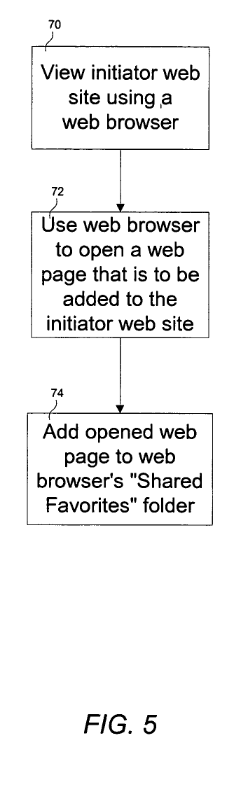

As generally depicted in FIG. 5, the collection and organization of web site content, before building the final web site of FIG. 2, may also be implemented using the following functional steps:
(1) The user views a pre-configured initiator web site using web browser 28, step 70. The initiator web site contains a pre-designated “Shared Favorites” folder.
(2) The user uses web browser 28 to open a web page that is to be added to the initiator web site, step 72. The web page may reside in memory on the user's computer or on any other suitable type of computer storage media that is readily accessible from the user's computer. Such computer storage media may be accessible via the Internet or by any other suitable means.
(3) The user adds the opened web page to the “Shared Favorites” folder by invoking the functionality of web browser 28, step 74. The web page is subsequently used by WSBM 34 to autonomously build the final web site.
The above steps may be repeated until all desired web pages have been added to the “Shared Favorites” folder by the user.

The generated (final) web site may be easily shared with other users in a number of ways. For example, the generated web site may be stored on a portable computer storage media such as a USB hard drive, a DVD (Digital Video Disc) in any of its varieties such as DVD−R, DVD−RW, DVD+R, DVD+RW, DVD-RAM, a CD (Compact Disc) such as CD-R, CD-RW, tape, or any other suitable memory storage device. To view the web site, users would simply need to load and run the portable web site media on their computers.

Alternatively, the generated (final) web site may be uploaded for storage to an ISP (Internet Service Provider) server. Thereafter, users, provided with the URL created in reference to step 44 (FIG. 2), may access the web site by simply typing the URL in their appropriate web browser field and hitting their web browser “GO” button. Once connected to the web site, users may modify the content on the web site via a secure login/password procedure or the like.

Another way to share web site content with other users may involve accessing the web site via a LAN (Local Area Network) or VPN (Virtual Private Network), or the like. Any logged-in member of the network would be able to bring up the web site on their screen by simply typing the previously supplied (by the original user) URL, created in reference to step 44 (FIG. 2), in their appropriate web browser field and hitting their web browser “GO” button. Thereafter, users may modify the content on the web site via a secure login/password procedure or the like. Other ways to share and/or modify web site content may be utilized provided such other ways do not depart from the intended purpose of the invention.

A person skilled in the art would undoubtedly recognize that any web site generated, as generally outlined hereinabove, may serve as an initiator web site, as generally described hereinabove in reference to FIGS. 2-5, for any future web site creations, revisions, modifications, or the like.

A person skilled in the art would readily appreciate that browser-based web site generation system 20, as generally described hereinabove, may be implemented on a portable USB hard drive, CD-RW, DVD+RW, or may be made available for download from an ISP server, or the like.

A person skilled in the art would undoubtedly recognize that other components and/or configurations may be utilized in the above-described embodiments. Moreover, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

While the invention has been described in detail with regards to several embodiments, it should be appreciated that various modifications and/or variations may be made in the invention without departing from the scope or spirit of the invention. In this regard it is important to note that practicing the invention is not limited to the applications described hereinabove. Many other applications and/or alterations may be utilized provided that such other applications and/or alterations do not depart from the intended purpose of the invention. Also, features illustrated or described as part of one embodiment can be used in another embodiment to provide yet another embodiment such that the features are not limited to the embodiments described hereinabove. Thus, it is intended that the invention cover all such embodiments and variations as long as such embodiments and variations come within the scope of the appended claims and their equivalents.

1. A web site generation system configured for collecting, organizing and viewing web site content information by way of a web browser, the web site generation system being adapted to autonomously generate a web site after the web site content information is collected and organized upon a single web site build command by way of the web browser.

2. A system for generating a web site, said system comprising:
(a) a client virtual machine (VM) adapted to run on at least one computing device as a foreground process and interface with a user, the client VM including a web browser;
(b) a server virtual machine (VM) adapted to run on at least one computing device as a background process and communicate remotely with the client VM in response to an action request from the web browser, the server VM adapted to autonomously generate a web site upon a single web site build command from the user by way of the web browser, the generated web site including at least one content file and at least one web page; and
(c) a storage virtual machine (VM) operatively coupled between the client VM and the server VM, the storage VM being used to store the at least one content file and the at least one web page.

3. The system of claim 2, wherein the client VM further includes at least one client applications module (CAM) and at least one graphical user interface (GUI), the at least one CAM adapted to interact with the web browser via the at least one GUI.

4. The system of claim 3, wherein the server VM includes at least one web server module (WSM), at least one web site content organization module (WSCOM) and at least one web site build module (WSBM), the at least one WSM being adapted to load and run the at least one WSCOM and the at least one WSBM, the web browser being operatively coupled to the at least one WSM.

5. The system of claim 4, wherein the at least one WSCOM is adapted to communicate remotely with the at least one CAM upon at least one user request to collect and organize web site content.

6. The system of claim 5, wherein the storage VM includes at least one content file storage module (CFSM) and at least one web page storage module (WPSM).

7. The system of claim 6, wherein the CFSM is operatively coupled between the at least one CAM and the at least one WSBM.

8. The system of claim 7, wherein the at least one WSBM is adapted to autonomously generate a web site upon a single web site build command from the user by way of the web browser, the generated web site including at least one content file and at least one web page, the at least one web page being stored in the at least one WPSM.

9. A method for generating a web site, said method comprising the steps of:
(a) presenting an initiator web site using a web browser;
(b) using the initiator web site to collect and organize web site content information;
(c) clicking once on the initiator web site to build a final web site; and
(d) autonomously building the final web site.

10. A web site content collection and organization method, said method comprising the steps of:
(a) viewing an initiator web site using a web browser;
(b) clicking on a content hyperlink on the initiator web site to open a target folder;
(c) locating a source folder using the functionality of the initiator web site; and
(d) copying and pasting web site content files from the source folder to the target folder.

11. A web site content collection and organization method, said method comprising the steps of:
(a) viewing an initiator web site using a web browser;
(b) clicking on the initiator web site to open a dialog box;
(c) navigating the dialog box to select at least one web site content folder;
(d) navigating the dialog box to select at least one web site content category; and
(e) associating the at least one selected web site content category with the at least one selected web site content folder.

12. A web site content collection and organization method, said method comprising the steps of:
(a) viewing an initiator web site using a web browser, the initiator web site having at least one “Shared Favorites” folder;
(b) using the web browser to open at least one web page that is to be added to the initiator web site; and
(c) adding the at least one opened web page to the at least one “Shared Favorites” folder.
